(19) United States
(12) Patent Application Publication
(10) Pub. No.: US 2010/0256298 A1
(43) Pub. Date: Oct. 7, 2010

(54) Preparation of Micro Gel Particle Dispersions and Dry Powders Suitable For Use As Fluid Loss Control Agents

(75) Inventors: Jun Jim Wu, Houston, TX (US); Ryan G. Ezell, Spring, TX (US)

Correspondence Address: STREETS & STEELE, 13100 WORTHAM CENTER DRIVE, SUITE 245, HOUSTON, TX, 77065, US

(73) Assignee: CHAMPION TECHNOLOGIES, INC., Houston, TX (US)

(21) Appl. No.: 12/418,322

(22) Filed: Apr. 3, 2009

(51) Int. Cl. C08L 33/10; C08L 33/24; C08L 41/00

(52) U.S. Cl. 524/812; 524/800; 524/832; 524/817

(57) ABSTRACT

This invention relates to dispersions and powders of micro gel particles, and more specifically, at least in some instances, dispersions of micro gel particles formed from crosslinked water-soluble or swellable polymers, and methods of preparing such micro gel particle dispersions. In one aspect, the invention provides a method of preparing synthetic micro gel particles, comprising forming a reaction mixture by dissolving or swelling a water-soluble or water-swellable unsaturated monomer, unsaturated crosslinking agent, and radical initiator in a common solvent that is substantially inert toward chain transfer reactions, wherein the monomer and the crosslinking agent polymerize to form crosslinked polymer micro gel particles that are insoluble or at most swellable in the common solvent.

### BACKGROUND OF THE INVENTION

1. Field of the Invention

This invention relates to micro gel particles, and more specifically, at least in some embodiments, compositions and methods relating to dispersions and powders of micro gel particles including crosslinked water-soluble or swellable polymers.

2. Background

Micro gels, as that term is used herein, are high molecular weight macromolecules that are crosslinked to form a network structure that may have a molecular weight ranging from 100,000 to 1,000,000,000,000 grams per mole, depending upon crosslinking density and particle size. Micro gels can be prepared with desirable microstructure and swellability, as well as other unique properties, which make micro gels particularly useful for a wide range of applications.

Micro gels have been prepared by various polymerization methods that are either limited to certain types of monomers or are complicated in nature. These methods may be further complicated by the presence of multiple types of reactive bonds, and the interaction between propagating radical and reaction medium.

Crosslinked micro gel particles based upon hydrophobic monomers, such as styrene, are generally prepared by either suspension or emulsion polymerization mechanisms, in which water is used as the reaction medium. Such polymerization mechanisms, however, are not suitable for the preparation of micro gels formed from water-soluble polymers. Examples of methods for making micro gels based on water-soluble polymers usually involve reverse emulsion (water-in-oil) and solution polymerizations. Unfortunately, many of these processes render limited polymer contents and require significant post-reaction treatments. For example, reverse emulsion polymerization may be difficult to utilize because of the limited solubility of monomer in the water phase of the emulsion. Solution polymerization can lead to the formation of a macro gel that is thick and difficult in post-treatment processes, such as grinding.

### SUMMARY OF THE INVENTION

The present invention provides methods of preparing synthetic micro gel particles.

In one embodiment, a method comprises forming a reaction mixture by dissolving or swelling a water-soluble or water-swellable unsaturated monomer, an unsaturated crosslinking agent, and a radical initiator in a common solvent that is substantially inert toward chain transfer reactions, wherein the unsaturated monomer and the unsaturated crosslinking agent polymerize to form crosslinked polymer micro gel particles that are insoluble or at most swellable in the common solvent. Suitable common solvents include, without limitation, ethanol, t-butanol/water and ammonium sulfate/water.

The description or the construction of the claims should not be limited by any description contained in the following section.

### DESCRIPTION OF SPECIFIC EMBODIMENTS

This invention relates to dispersions and dry powders of micro gel particles, and more specifically, at least in some embodiments, dispersions and dry powders of micro gel particles formed from crosslinked water-soluble or swellable polymers, and methods of preparing such micro gel particle dispersions and dry powders. Although the word “micro” is used in this disclosure, it is not a limiting term, and therefore, a micro gel particle may have a size smaller than a micrometer.

In some embodiments, the methods of preparing synthetic micro gel particles provided by the present invention comprise conducting a dispersion polymerization of a water-soluble or water-swellable unsaturated monomer in the presence of an unsaturated crosslinking agent, a radical initiator and a common solvent that is substantially inert toward chain transfer reactions, wherein the common solvent is a solvent for the monomer, crosslinking agent and radical initiator, yet a nonsolvent to the resultant polymeric micro gel. In some embodiments, conducting a dispersion polymerization may comprise dissolving or swelling a water-soluble or water-swellable unsaturated monomer, an unsaturated crosslinking agent, and a radical initiator in a common solvent that is substantially inert toward chain transfer reactions, and then polymerizing the monomer and the crosslinking agent to form crosslinked polymeric micro gel particles that are substantially insoluble in the common solvent.

The selection of the common solvent can be important in the performance of these methods. The selection of the common solvent can be interdependent upon the selection of the monomer, crosslinking agent, radical initiator and any stabilizer that may be included, as well as the resulting micro gel being produced. Each of the monomer, crosslinking agent, radical initiator and any stabilizer preferably should be soluble or at least swellable in the common solvent, yet the resulting micro gel should be insoluble or at most swellable in the common solvent. Accordingly, a common solvent that is suitable for a certain combination of monomer species, crosslinking agent species and radical initiator species, may not be suitable for other combinations. Furthermore, the concentrations of the monomer species, crosslinking agent species, radical initiator species and any stabilizer species may impact the physical properties of the resulting micro gels and alter the condition of the micro gel at which it will precipitate out of the solvent. Changes may be made in the selected species and concentration of the monomer, crosslinking agent, radical initiator and any stabilizer so that the micro gel particles precipitating from the solvent will have the desired properties.

It should be recognized that dispersion polymerization, unlike emulsion polymerization, is not believed to form an emulsion. Rather, dispersion polymerization is believed to occur in a continuous phase that comprises a solvent. As used herein, the term “solvent” or “common solvent” includes a single liquid, a solution or mixture of multiple liquids, or a solution of one or more solutes dissolved in one or more liquids. The word “common” in the term “common solvent” means that the solvent solubilizes or swells each of a defined group of components, yet it may not solubilize or swell other components. In accordance with the invention, the common solvent solubilizes or at least swells the monomer, crosslinking agent, and radical initiator, but does not solubilize or at most swell, or perhaps poorly solubilizes or swells, the resulting micro gel particles. The term “solubilize” used in this invention refers to the process of forming a homogeneous solution of the monomer, crosslinking agent, and radical initiator in the common solvent. In contrast, the term “swell” used in this invention refers to the process of forming a somewhat non-homogeneous solution or dispersion, as a result of favorable molecular interactions of the common solvent with perhaps only a certain portion or segment of a solute molecule such as the monomer, crosslinking agent and radical initiator. The common solvent typically comprises from about 0.01 to about 99 wt % of the reaction mixture.

The common solvent should also be “substantially inert toward chain transfer reactions.” The term “substantially inert toward chain transfer reactions,” as used herein, refers to the propensity of the common solvent to not interfere with the polymerization reactions and crosslinking reaction in the dispersion polymerization in such a manner as to prevent or hinder the formation of micro gels in the dispersion. It is believed that a solvent that is substantially inert toward chain transfer reactions will not kill the propagating radical. Common solvents that are “substantially inert toward chain transfer reactions” preferably will not have reactive hydrogen. Suitable common solvents that are substantially inert toward chain transfer reactions may include, without limitation, methanol, ethanol, n-propanol, isopropanol, n-butanol, sec-butanol, isobutanol, t-butanol, a mixture of methanol, ethanol, n-propanol, isopropanol, n-butanol, sec-butanol, isobutanol, or t-butanol and water, a mixture of ammonium sulfate, sodium sulfate, or potassium sulfate and water, a mixture of sodium chloride, potassium chloride, or calcium chloride and water, and combinations thereof. The inertness of a prospective solvent can be evaluated by performing a first polymerization reaction using the prospective solvent in a polymerization reaction mixture and comparing the results with those obtained by performing a second polymerization reaction using a reaction mixture that is identical in all respects except for the substitution of a solvent that is known to be inert. An increase of the swellability and/or an increase of the linear (or GPC-detectable; GPC refers to gel permeation chromatography) polymer content of the micro gel particles resulting from polymerization with the prospective solvent (i.e., the first polymerization reaction), relative to micro gel particles obtained using the solvent known to be inert (i.e., the second polymerization reaction), are indicators that the prospective solvent exhibits poor inertness. A prospective solvent is substantially inert toward chain transfer reactions if the swellability and linear or GPC-detectable polymer content of the micro gel particles obtained using the prospective solvent in the first polymerization reaction is similar to the micro gel particles obtained using the solvent known to be inert in the second polymerization reaction.

In an optional further embodiment, the common solvent is preferably volatile to facilitate its removal by evaporation following the preparation of the micro gel particle dispersions. This embodiment provides a convenient and economical procedure for obtaining a dry powder of the micro gel. Other separation procedures may also be used in combination with evaporation or instead of evaporations. For example, it may be desirable to centrifuge the reaction medium following formation of the micro gel particles to remove a large portion of the excess common solvent before using evaporation to dry the particles. Centrifuging and decanting the common solvent also facilitates the reuse of excess common solvent without using a more complex solvent vapor recovery system.

In some embodiments, the monomer may include an unsaturated group, such as a monomer including a vinyl group. Exemplary vinyl-containing monomers may be described by the formula C(R₁)(R₂)═C(R₃)(R₄), wherein R₁, R₂, R₃ and R₄ are segments rendering the solubility or swellability of this monomer in the common solvent. Optionally, R₁, R₂, R₃ and R₄ can each be independently selected from, but not limited to, hydrogen, methyl, ethyl, CONH₂, CONHCH₃, CON(CH₃)₂, CH₂SO₃H, CH₂SO₃Na and COONa. In certain embodiments, the monomer comprises a compound selected from acrylamide and 2-hydroxyethyl methacrylate. In some embodiments, the monomer may further comprise an inorganic monomer, and the polymeric microgel particles may include copolymers having a combination of inorganic and organic units. Optionally, the monomer comprises from about 0.01 wt % to about 50 wt % of the reaction mixture.

In another embodiment, the crosslinking agent (alternatively referred to as a “crosslinker” but both having the same meaning) is a compound that has at least two sites that can be linked to different polymer chains. One type of this crosslinker is an unsaturated compound represented by the formula CH₂═CH—R₅—CH═CH₂, where R₅ is an organic group rendering solubility or swellability of this crosslinker to the common solvent. One alternative formula for a crosslinking agent is represented by the formula C(R₆)(R₇)═C(R₈)—R₉—C(R₁₀)═C(R₁₁)(R₁₂), where R₆-R₁₂ are organic groups rendering solubility and swellability of this crosslinker to the reaction medium. In a preferred embodiment, the monomer is an amide and the crosslinking agent includes two amide groups coupled by an organic group. In certain embodiments, the crosslinking agent comprises a compound selected from the group consisting of N,N′-ethylene-bisacrylamide, N,N′-methylene-bisacrylamide, ethylene glycol dimethacrylate, diethylene glycol dimethacrylate, polyethylene glycol dimethacrylate, ethylene glycol diacrylate, diethylene glycol diacrylate, and polyethylene glycol methacrylate. Optionally, the crosslinking agent comprises from about 0.01 wt % to about 20 wt % of the reaction mixture. More preferably, the crosslinking agent comprises about 0.01% to about 1% of the reaction mixture. About 0.18 wt % crosslinking agent may be preferred in some instances. Optionally, the crosslinking agent is radically polymerizable. The term “organic group,” as used herein, broadly refers to a carbon-containing portion of a molecule. The organic group may include, but is not required to include, any number of heteroatoms or functional groups.

In yet another embodiment, the radical initiator includes a thermal initiator, wherein the thermal initiator comprises a compound selected from the group consisting of azobisisobutyronitrile, 2,2′-azobis-(2-methylbutyronitrile), 2,2′-azobis(isobutyramidine hydrochloride), 2,2′-azobis[2-(2-imidazolin-2-yl)propane]dihydrochloride, 1,1′-azobis(cyclohexanecarbonitrile), 2,2′-azobis(2-methylpropionamidine)dihydrochloride, 4,4′-azobis(4-cyanovaleric acid), 4,4′-azobis(4-cyanovaleric acid), ammonium persulfate, hydroxymethanesulfinic acid monosodium salt dihydrate, potassium persulfate, sodium persulfate, benzoyl peroxide, 1,1-bis(tert-amylperoxy)cyclohexane, 1,1-bis(tert-butylperoxy)-3,3,5-trimethylcyclohexane, 1,1-bis(tert-butylperoxy)cyclohexane, 2,2-bis(tert-butylperoxy)butane, 2,4-pentanedione peroxide, 2,5-bis(tert-butylperoxy)-2,5-dimethylhexane, 2,5-di(tert-butylperoxy)-2,5-dimethyl-3-hexyne; 2-butanone peroxide, cumene hydroperoxide, di-tert-amyl peroxide, dicumyl peroxide, lauroyl peroxide, tert-butyl hydroperoxide, tert-butyl peracetate, tert-butyl peroxide, tert-butyl peroxybenzoate, tert-butylperoxy-2-ethylhexyl carbonate and combinations thereof. The radical initiators may also include organic photoinitiators or combinations thereof, or combinations of thermal and photoinitiators. Optionally, the radical initiator comprises from about 0.0001 wt % to about 20 wt % of reaction mixture. More preferably, the initiator comprises about 0.01% to about 5% of the reaction mixture. About 0.022 wt % radical initiator may be preferred in some instances. In some embodiments, the radical initiator may be added to the common solvent at the same time as the monomer and crosslinker, yet in other embodiments the radical initiator may be added later.

Another embodiment of the invention may optionally include adding a colloidal stabilizer into the common solvent, wherein the colloidal stabilizer is soluble or at least swellable in the reaction medium. In a specific embodiment, the colloidal stabilizer may be amphiphilic. Suitable examples include a stabilizer comprising a compound selected from the group consisting of poly(vinyl pyrrolidone) (PVP), polydiallyldimethylammonium chloride (poly-DADMAC), and combinations thereof. Optionally, the colloidal stabilizer comprises from about 0.001 to about 20 wt % of the reaction mixture. It is believed that, at least in some embodiments, the colloidal stabilizer may become incorporated into the micro gel.

Although micro gel particles may be used in various applications as produced with or without drying, further embodiments may include grinding or other post treatments.

In yet another embodiment, first and second micro gel species may be formed in accordance with the invention and mixed for use in various applications. The first and second micro gel species are different in one or more aspects, such as monomer species, crosslinking species, molecular weight, crosslinking percentage, and combinations thereof. Furthermore, the first and second micro gel species may be mixed wet or dry, and with or without grinding or other post treatments. Optionally, the mixtures may include any number of micro gel species that differ in one or more aspects, such as monomer species, crosslinking species, molecular weight, crosslinking percentage, and combinations thereof.

To facilitate a better understanding of the present invention, the following examples of certain aspects of some embodiments are given. The following examples should not be read to limit or define the entire scope of the invention.

### EXAMPLE 1

### Dispersion Polymerization of Acrylamide in Ethanol

The following procedure was followed to prepare polyacrylamide micro gels in ethanol. A three-neck flask (250 mL), equipped with a condenser and a mechanical stirrer, was filled with absolute ethanol (95.0 g), acrylamide (20.0 g), poly(vinyl pyrrolidone) (PVP; 0.50 g) and diethylene glycol dimethacrylate (0.50 g). The mixture was purged with N₂ for 30 min before it was heated to 65° C. A solution of azobisisobutyronitrile [AIBN; 0.05 g in ethanol (5.0 g)] was injected. The reaction was kept at 65° C. under N₂ and stirring [rotation per min (rpm)=300] for 22 h, before it was cooled to room temperature. A dispersion of particles (solids content of ca. 17 wt %) was obtained.

### EXAMPLE 2

### Dispersion Polymerization of Acrylamide in t-Butanol/Water

The following procedure was followed to prepare polyacrylamide micro gels in t-butanol/water. A three-neck flask (250 mL), equipped with a condenser and a mechanical stirrer, was filled with a mixture of t-butanol/water (90/10 w/w; 90.0 g), acrylamide (15.0 g) and poly(vinyl pyrrolidone) (PVP; 0.50 g). The mixture was purged with N₂ for 30 min before it was heated to 65° C. A solution of azobisisobutyronitrile [AIBN; 0.05 g in ethanol (5.0 g)] was injected. At ca. 20 min after initiation, a solution of N,N′-ethylene-bis-acrylamide [0.10 g in t-butanol/water (90/10 w/w; 5.0 g)] was injected. The reaction was kept at 65° C. under N₂ and stirring [rotation per min (rpm)=300] for 22 h, and then cooled to room temperature. A dispersion of particles (solids content ca. 13 wt %) with particle size from 10 to 300 μm was obtained.

### EXAMPLE 3

### Dispersion Polymerization of Acrylamide in t-Butanol/Water

The same procedure as in Example 2, except that at ca. 20 min after initiation, a solution of N,N′-ethylene-bis-acrylamide [0.40 g in t-butanol/water (90/10 w/w; 5.0 g)] was injected.

### EXAMPLE 4

### Dispersion Polymerization of Acrylamide in t-Butanol/Water

The same procedure as in Example 2, except that at ca. 20 min after initiation, a solution of N,N′-ethylene-bis-acrylamide [0.20 g in t-butanol/water (90/10 w/w; 5.0 g)] was injected.

### EXAMPLE 5

### Dispersion Polymerization of Acrylamide in t-Butanol/Water

The same procedure as in Example 2, except that at ca. 20 min after initiation, a solution of N,N′-ethylene-bis-acrylamide [0.050 g in t-butanol/water (90/10 w/w; 5.0 g)] was injected.

### EXAMPLE 6

### Dispersion Polymerization of Acrylamide in t-Butanol/Water

A three-neck flask (250 mL), equipped with a condenser and a mechanical stirrer, was filled with a mixture of t-butanol/water (90/10 w/w; 95.0 g), acrylamide (15.0 g), N,N′-ethylene-bis-acrylamide (0.20 g) and poly(vinyl pyrrolidone) (PVP; 0.50 g). The mixture was purged with N₂ for 30 min before it was heated to 65° C. A solution of azobisisobutyronitrile [AIBN; 0.05 g in ethanol (5.0 g)] was injected. The reaction was kept at 65° C. under N₂ and stirring [rotation per min (rpm)=300] for 22 h, and then cooled to room temperature. A dispersion of particles (solids content ca. 13 wt %) with particle size from 10 to 300 μm was obtained.

### EXAMPLE 7

### Brine Dispersion Polymerization of Acrylamide

The following procedure was followed for brine dispersion micro gels. A three-neck flask (250 mL), equipped with a condenser and a mechanical stirrer, was filled with ammonium sulfate (40% solution, 75.5 g), acrylamide (7.5 g), polydiallyldimethylammonium chloride (poly-DADMAC) (20%, 12.0 g), poly(ethylene glycol) diacrylate (6.7 μL) and de-ionized water (20.0 g). The mixture was purged with N₂ for 30 min before it was heated to 35° C. A solution of VA-044 {2,2′-azobis[2-(2-imidazolin-2-yl)propane]dihydrochloride; 5.0 mg in water (5.0 g)} was injected. The reaction was kept at 35° C. under N₂ and stirring [rotation per min (rpm)=300] for 22 h, and then cooled to room temperature. A dispersion of particles (polymer content ca. 9 wt %) was obtained.

### EXAMPLE 8

### Brine Dispersion Polymerization of Acrylamide

The same procedure as in Example 7, except that poly(ethylene glycol) diacrylate (67 μL) was added.

### EXAMPLE 9

### Dry Powders from Examples 1-8

The dispersion or slurry of each individual Example (1-8) was centrifuged at 4800 rpm for 5 min. The supernatant was decanted and the sediments collected. The sediments were then dried under vacuum at ca. 50° C. for overnight to generate loose, well dispersed dry powder.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, components and/or groups, but do not preclude the presence or addition of one or more other features, integers, steps, operations, elements, components, and/or groups thereof. The terms “preferably,” “preferred,” “prefer,” “optionally,” “may,” and similar terms are used to indicate that an item, condition or step being referred to is an optional (not required) feature of the invention. Every range given with respect to any element is defined to include every included range as if specifically set forth herein.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but it not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method of preparing synthetic micro gel particles, comprising:
forming a reaction mixture by dissolving or swelling a water-soluble or water-swellable unsaturated monomer, unsaturated crosslinking agent, and radical initiator in a common solvent that is substantially inert toward chain transfer reactions, wherein the unsaturated monomer and the unsaturated crosslinking agent polymerize to form crosslinked polymer micro gel particles that are insoluble or at most swellable in the common solvent.

2. The method of claim 1, wherein the common solvent comprises a fluid selected from the group consisting of methanol, ethanol, n-propanol, isopropanol, n-butanol, sec-butanol, isobutanol, t-butanol, a mixture of methanol, ethanol, n-propanol, isopropanol, n-butanol, sec-butanol, isobutanol, or t-butanol and water, a mixture of ammonium sulfate, sodium sulfate, or potassium sulfate and water, a mixture of sodium chloride, potassium chloride, or calcium chloride and water, and combinations thereof.

3. The method of claim 1, wherein the common solvent comprises a fluid selected from the group consisting of ethanol, a mixture of t-butanol and water, and a mixture of ammonium sulfate and water.

4. The method of claim 1, wherein the micro gel particles are water-soluble or water-swellable.

5. The method of claim 1, wherein the common solvent is a t-butanol/water solution having a t-butanol:water weight ratio greater than about 0.01.

6. The method of claim 1, wherein the unsaturated monomer comprises a compound selected from the group consisting of acrylamide and 2-hydroxyethyl methacrylate.

7. The method of claim 1, wherein the unsaturated monomer is acrylamide.

8. The method of claim 1, wherein the water-soluble or swellable unsaturated monomer is C(R₁)(R₂)═C(R₃)(R₄), wherein R₁, R₂, R₃ and R₄ are organic groups rendering the solubility or swellability of this monomer to water and the reaction mixture.

9. The method of claim 8, wherein R₁, R₂, R₃ and R₄ are each independently selected from the group consisting of hydrogen, methyl, ethyl, CONH₂, CONHCH₃, CON(CH₃)₂, CH₂SO₃H, CH₂SO₃Na and COONa.

10. The method of claim 1, wherein the unsaturated crosslinking agent comprises a compound selected from the group consisting of N,N′-ethylene-bisacrylamide, N,N′-methylene-bisacrylamide, ethylene glycol dimethacrylate, diethylene glycol dimethacrylate, polyethylene glycol dimethacrylate, ethylene glycol diacrylate, diethylene glycol diacrylate, and polyethylene glycol methacrylate.

11. The method of claim 1, wherein the unsaturated crosslinking agent comprises a compound selected from the group consisting of N,N′-ethylene-bis-acrylamide and diethylene glycol dimethacrylate.

12. The method of claim 1, wherein the unsaturated crosslinking agent is represented by CH₂═CH—R₅—CH═CH₂, where R₅ is an organic group rendering the unsaturated crosslinking agent soluble in the common solvent.

13. The method of claim 1, wherein the unsaturated crosslinking agent is represented by C(R₆)(R₇)═C(R₈)—R₉—C(R₁₀)═C(R₁₁)(R₁₂), where R₆ to R₁₂ are organic groups rendering solubility and swellability of the unsaturated crosslinking agent to water and the reaction medium.

14. The method of claim 1, wherein the radical initiator comprises a compound selected from the group consisting of azobisisobutyronitrile, 2,2′-azobis-(2-methylbutyronitrile), 2,2′-azobis(isobutyramidine hydrochloride), 2,2′-azobis[2-(2-imidazolin-2-yl)propane]dihydrochloride, 1,1′-azobis(cyclohexanecarbonitrile), 2,2′-azobis(2-methylpropionamidine)dihydrochloride, 4,4′-azobis(4-cyanovaleric acid), 4,4′-azobis(4-cyanovaleric acid), ammonium persulfate, hydroxymethanesulfinic acid monosodium salt dihydrate, potassium persulfate, sodium persulfate, benzoyl peroxide, 1,1-bis(tert-amylperoxy)cyclohexane, 1,1-bis(tert-butylperoxy)-3,3,5-trimethylcyclohexane, 1,1-bis(tert-butylperoxy)cyclohexane, 2,2-bis(tert-butylperoxy)butane, 2,4-pentanedione peroxide, 2,5-bis(tert-butylperoxy)-2,5-dimethylhexane, 2,5-di(tert-butylperoxy)-2,5-dimethyl-3-hexyne; 2-butanone peroxide, cumene hydroperoxide, di-tert-amyl peroxide, dicumyl peroxide, lauroyl peroxide, tert-butyl hydroperoxide, tert-butyl peracetate, tert-butyl peroxide, tert-butyl peroxybenzoate, tert-butylperoxy-2-ethylhexyl carbonate and combinations thereof.

15. The method of claim 1, wherein the radical initiator comprises a compound selected from the group consisting of azobisisobutyronitrile, 2,2′-azobis[2-(2-imidazolin-2-yl)propane]dihydrochloride, and combinations thereof.

16. The method of claim 1, wherein the radical initiator comprises an initiator selected from the group consisting of photoinitiators, thermal initiators, and combinations thereof.

17. The method of claim 1, wherein the radical initiator is added after dissolving or swelling the monomer and the crosslinking agent in the common solvent.

18. The method of claim 1, further comprising evaporating the common solvent after forming the micro gel particles to obtain the micro gel particles as a dry powder.

19. The method of claim 1, further comprising treating the micro gel particles with a process that involves centrifugation, drum-drying, grinding, or a combination thereof.

20. The method of claim 1, further comprising mixing a first micro gel species with a second micro gel species, wherein the first and second micro gel species are different.

21. The method of claim 1, further comprising mixing a first micro gel species formed with a first concentration of the unsaturated crosslinking agent with a second micro gel species formed with a second concentration of the unsaturated crosslinking agent, wherein the first and second concentrations are different.

22. The method of claim 1, wherein the unsaturated crosslinking agent is added after the polymerization has been initiated by the radical initiator.

23. A method of preparing synthetic micro gel particles, comprising:
forming a reaction mixture by dissolving or swelling a water-soluble or water-swellable unsaturated monomer, unsaturated crosslinking agent, colloidal stabilizer, and radical initiator in a common solvent that is substantially inert toward chain transfer reactions, wherein the unsaturated monomer and the unsaturated crosslinking agent polymerize to form crosslinked polymer micro gel particles that are insoluble or at most swellable in the common solvent, wherein the colloidal stabilizer is soluble or swellable in the common solvent and increases the colloidal stability of the crosslinked polymer micro gel particles.

24. The method of claim 23, wherein the colloidal stabilizer is amphiphilic.

25. The method of claim 24, wherein the amphiphilic colloidal stabilizer comprises a stabilizer selected from the group consisting of poly(vinyl pyrrolidone) (PVP), polydiallyldimethylammonium chloride (poly-DADMAC), and combinations thereof.

26. The method of claim 23, wherein the colloidal stabilizer comprises between about 0.01 and about 20 weight percent of the reaction mixture.

27. The method of claim 23, wherein the micro gel particles remain separable from the continuous phase.
